(19) United States
(12) Patent Application Publication
(10) Pub. No.: US 2012/0027473 A1
(43) Pub. Date: Feb. 2, 2012

(54) INTERMEDIATE TRANSFER MEMBER

(76) Inventors: Daishi Yamashita, Tokyo (JP); Yuichiro Maehara, Tokyo (JP)

(21) Appl. No.: 13/255,056

(22) PCT Filed: Feb. 17, 2010
(86) PCT No.: PCT/JP2010/052330

§ 371 Date: Sep. 6, 2011

(30) Foreign Application Priority Data
Mar. 11, 2009 (JP) 2009-057836

(51) Int. Cl. G03G 15/20

(52) U.S. Cl. 399/308

(57) ABSTRACT

An excellent intermediate transfer member which, even when used for printing on a plurality of sheets, does not crack to thereby cause image defects and can retain satisfactory cleaning ability without suffering toner filming, and with which high-quality printed images free from fog caused by toner filming are continuously obtained. The intermediate transfer member is for use in an image-forming device having a means of first transferring a toner image deposited on the surface of an electrophotographic photoreceptor to an intermediate transfer member and then secondly transferring the toner image from the intermediate transfer member to a receiving material. The intermediate transfer member comprises a resin base, and formed on the periphery thereof, an elastic layer and a surface layer, the surface layer being composed of an interlayer and a rigid layer, the interlayer being a layer having a lower hardness and a lower modulus than the rigid layer.

### TECHNICAL FIELD

The present invention relates to an intermediate transfer member, more in detail an intermediate transfer member having a surface layer on an elastic layer used for image forming via an electrophotography.

### BACKGROUND

Hitherto, there have been methods using a member called intermediate transfer member in a belt shape or a drum shape in addition to a method transferring the toner image directly on a transfer material when a toner image formed on surface of the electrophotographic photoreceptor (“photoreceptor”) is transferred to transfer material such as a paper in an image forming via an electrophotography. This method includes two transfer steps; one is the first transfer in which the toner image from the electrophotographic photoreceptor to an intermediate transfer member to form a toner image, and the other the second transfer in which the toner image on intermediate transfer member is transferred on a transfer material. The intermediate transfer method is used for so called a full color image employing plural kinds of toners such as a black, cyan, magenta and yellow toner. In this method each color toner images formed on single or plural photoreceptors is transferred on the intermediate transfer member to superpose them in sequence and finally all color toners are transferred from the intermediate transfer member to the transfer material in a so called full color image forming apparatus.

The mediate transfer member required high durability since toner image transferring and removing residual toner after transferring were conducted repeatedly. Therefore, a resin member having high durability represented by polyimide has been used widely, however the member composed of such member is usually hard and is inferior in close adhesion to surface of the photoreceptor, and therefore has problem that it is difficult to transfer a toner image on the photoreceptor equally on the intermediate transfer member.

It is difficult to transfer the toner image on the photoreceptor to intermediate transfer member surface equally and uniformly because of existence of hard resin member, and an image defects called hollow image in which a part of predetermined toner is omitted are found. This problem is remarkable when a letter image is formed and affects to image quality greatly. Further, there has been a problem of image stain or intra machine stain caused by scattering of residual toner on the photoreceptor without transferring to intermediate transfer member. In these circumstances, a technology to providing an elastic layer on intermediate transfer member has been studied to transfer the toner image certainly on the photoreceptor, (for example, see, Patent Documents 1 to 3).

On the other side, a certain degree of hardness is required when a toner image transferred on intermediate transfer member surface is transferred on a transfer material such as papers. This is because intermediate transfer member surface cannot maintain its shape by abrasion caused during transferring. Therefore the technologies described in the above shown Patent Documents were further required to study providing other layers such as an inorganic layer on the elastic layer to improve further durability taking into consideration of lowering transfer property due to existence of an elastic layer.

Technology described in, for example, Patent Document 1 aims not to cause transfer defects or image flow even after 60 thousand sheets of full color image forming by providing an inorganic coating having a thickness of 0.1 to 70 μm on an elastic layer.

Patent Document 2 inhibits damage or waste due to external force by providing a surface layer composed of high hardness and flat diamond-like carbon film.

Patent Document 3 discloses a technology in which an intermediate transfer member having a structure bonding fluorine compound chemically to the surface of elastic body is produced via atmospheric pressure plasma treatment in the semiconductive endless belt composed of an elastic body.

Further, an intermediate transfer member is disclosed, which has a surface layer carrying the toner image and an adjacent layer having smaller elasticity modulus than that of the surface layer for the purpose of inhibiting generation of cracks (for example, see, Patent Document 4).

Thus studies of the intermediate transfer member has been progressed to realize improvement of insuring transfer performance and durability by providing an elastic layer and other layers such as a surface layer on the elastic layer.

### PATENT DOCUMENT

Patent Document 1: JP-A 2000-206801
Patent Document 2: JP-A 2006-259581
Patent Document 3: JP-A 2003-165857
Patent Document 4: JP-A 2008-122847

### DESCRIPTION OF THE INVENTION

### Technical Problem to be Dissolved by the Invention

Patent Document 1 reports examples to improve cleaning performance, and prevent stain by toner on intermediate transfer member surface by providing an inorganic coating layer containing colloidal silica on an elastic body, and anti-abrasion performance is supposed to improve used as a surface layer pf intermediate transfer member in comparison with Patent Document 3. However, since colloidal silica is bonded via an organic layer, there is a fear that the organic layer is scraped to generate abrasion and cause generation of toner filming. Further there is a fear to generate cracks when increasing additive amount of colloidal silica for the purpose of improving anti-abrasion property.

Patent Document 2 reports examples forming a covering layer having high hardness and smoothness on an elastic body. However, transfer performance from the intermediate transfer member to transfer material is inhibited, and as the result, problems are caused such as hollow defect in a letter image and toner scattering since the covering layer covered on the elastic body is too hard when these are used in intermediate transfer member.

Patent Document 3 discloses an intermediate transfer member in which a layer composed of a fluorine compound is provided on an elastic body. In this case, abrasion generates by abrading by cleaning blade as a cleaning member since the fluorine compound formed on the surface is too soft, and it causes a problem deterioration of image is induced when a plenty sheets of printing is conducted.

An intermediate transfer member is investigated in which an adjacent layer (a paste state resin) is provided on a backing layer (insulating resin film), and further a surface layer (dispersing carbon black in a resin such as polyester) is provided, in Document 4. However, anti-abrasion performance of the surface layer is not sufficient and, there is a problem to generate toner filming.

The object of this invention is to provide an excellent intermediate transfer member by which high quality print images can be obtained continuously, without suffering image defects or toner filming caused by cracks, satisfactory cleaning ability is maintained and generation of image stain such as fog toner filming is minimized, even when a plenty sheets of printing (for example, 160 thousand sheets) is conducted.

### Technical Means to Dissolve Problem

The object of this invention can be attained by the following.

1. An intermediate transfer member used in an image forming apparatus having a means in which after a toner image carried on a surface of an electrophotographic photoreceptor is first transferred to an intermediate transfer member, the toner image is second transferred from the intermediate transfer member to a transfer material, wherein

the intermediate transfer member is provided with an elastic layer on outer periphery of a resin substrate and a surface layer thereon, wherein

the surface layer is composed of an interlayer and a rigid layer containing at least one selected from metal oxide, oxide containing carbon and amorphous carbon;

the interlayer has a layer thickness of not less than 100 nm and not more than 1,000 nm, hardness of not less than 0.1 GPa and not more than 2.0 GPa, and elasticity modulus of not less than 0.5 GPa and not more than 10.0 GPa; and

the rigid layer has a layer thickness of not less than 0 nm and not more than 50 nm, hardness of not less than 2.0 GPa and not more than 10.0 GPa, and elasticity modulus of not less than 10.0 GPa and not more than 50.0 GPa.

2. The intermediate transfer member of above described item 1, wherein the surface layer is formed by superposing layers containing one or more kinds of metal oxides.
3. The intermediate transfer member of above described item 1 or 2, wherein the surface layer is a layer composed of silicon oxide as a major component.
4. The intermediate transfer member of above described any one of items 1 to 3, wherein the surface layer is formed by means of plasma CVD in which two or more of voltages of different frequency are applied at atmospheric pressure or its neighborhood.
5. The intermediate transfer member of any one of items 1 to 4, wherein the elastic layer is a layer formed of at least one of chloroprene rubber, nitrile rubber, styrene-butadiene rubber, silicone rubber, urethane rubber and ethylene-propylene copolymer.
6. The intermediate transfer member of any one of items 1 to 5, wherein the resin substrate is composed of at least one of polyimide, polycarbonate, polyphenylene-sulfide and polyethylene terephthalate.

### ADVANTAGE OF THE INVENTION

The intermediate transfer member of the present invention has an excellent advantage that a high quality print images can be obtained continuously without defects caused by crack and suffering toner filming, and maintaining satisfactory cleaning ability, free from fog caused by toner filming, even when a plurality of sheets (for example, 160 thousand sheets) are printed.

### BRIEF DESCRIPTION OF DRAWINGS

FIG. 1: A schematic view of an example of a measuring device measuring hardness and elasticity modulus via a nanoindentation method.

FIG. 2: Typical load-displacement curve obtained by measuring hardness and elasticity modulus via a nanoindentation method.

FIG. 3: A schematic view showing state of contacting the indenter to a sample.

FIG. 4: Conceptual sectional schematic view showing layer arrangement of the intermediate transfer member.

FIG. 5: An explanation drawing showing the first manufacturing apparatus to manufacture a rigid layer of the intermediate transfer member.

FIG. 6: An explanation drawing showing the second manufacturing apparatus to manufacture a rigid layer of the intermediate transfer member.

FIG. 7: An explanation drawing showing the first plasma layer forming apparatus to manufacture a rigid layer of the intermediate transfer member by means of plasma.

FIG. 8: A schematic diagram showing an example of a roll electrode.

FIG. 9: Conceptual sectional schematic view of an example of an image forming apparatus applicable of an intermediate transfer member of the present invention.

### EMBODIMENT PRACTICING THIS INVENTION

The inventors of the present invention have studied an intermediate transfer member having an excellent advantage that a high quality print images can be obtained continuously without defects caused by crack and suffering toner filming, and maintaining satisfactory cleaning ability, free from fog caused by toner filming, even when a plurality of sheets (for example, 160 thousand sheets) are printed.

As a result of various studies, it has been found that an intermediate transfer member composed of an elastic layer provided on outer periphery of the resin substrate and a surface layer thereon, and having specific values of a layer thickness, hardness and elasticity modulus of the surface layer exhibits excellent characteristics in preventing generating image defects caused by crack and toner filming, maintaining cleaning performance, and durability.

Generation of toner dots near characters caused by toner scattering can be prevented when a toner image is transferred from an intermediate transfer member to a transfer material in case that a layer thickness of the interlayer and a rigid layer forming the surface layer are specified, since an electrical conductivity can be ensured even when a conductivity providing agent is not added to the surface layer. Further, it is assumed that slipping performance and anti-abrasion performance can be sufficiently exhibited without deteriorating physical properties of the surface layer as itself since it is not necessary to add a conductivity providing agent.

It is also assumed that generation of cracks or peel off of a rigid layer can be prevented by providing one or more interlayers which is softer than the rigid layer and harder than the elastic layer between the hardest rigid layer and a flexible elastic layer, whereby the interlayer works as a cushion.

It is also found that, a combination of a layer thickness, hardness and elasticity modulus of the rigid layer with the interlayer relates to characteristics of preventing generation of image defects caused by crack and toner filming, maintaining cleaning performance and durability.

Further, the intermediate transfer member is subjected to cleaning whereby remaining toner on the intermediate transfer member which is not removed without transferring is subjected to cleaning via cleaning member (for example, cleaning blade, fur brush, foam roller or combination thereof), after second transferring the toner image on the intermediate transfer member to a transfer material.

When the intermediate transfer member has a surface layer according to this invention, surface of the intermediate transfer member is not wound by a cleaning member, and remaining toner without transferred is cleaned. It is assumed that high quality toner images without print image stain caused by cleaning deficiency are obtained continuously even a plenty of sheets is printed, as its result.

A high quality toner images can be obtained free from fog, without image defects caused by crack, without suffering toner filming, without wound due to cleaning member by selecting above described characteristics, even though a plenty of sheets (for example, 160 thousand sheets) is printed.

First, a layer thickness, hardness and elasticity modulus stipulated by this invention are described.

### (Layer Thickness)

Thickness of the surface layer, the interlayer and the rigid layer is a value measured by using a measuring instrument Model MXP21 manufactured by Mac Science Inc. in the invention. The layer thickness can be conducted by the following method.

Thickness is measured using a measuring instrument Model MXP21 manufactured by Mac Science Inc. Practically copper is employed as a target of the X-ray source, and operation is performed at 42 kV with 500 mA. A multi-layer film parabolic mirror is used as an incident monochrometer. A 0.05 mm C: 5 mm incident slit and a 0.03 mm C: 20 mm light receiving slit are employed. According to the 2θ/θ scanning technology, measurement is conducted at a step width of 0.005° in the range from 0 to 5°, 10 seconds for each step by the FT method. Curve fitting is applied to the reflectivity curve having been obtained, using the Reflectivity Analysis Program Ver. 1 of Mac Science Inc. Each parameter is obtained so that the residual sum of squares between the actually measured value and fitting curve will be minimized. From each parameter, the layer thickness can be obtained.

The layer thickness of the interlayer is measured by such a way that a layer thickness of a surface layer (i.e., an interlayer and a rigid layer) is measured at first and then the rigid layer is removed by, for example, abrasion to expose an interlayer, whose thickness is measured by the above described method. The layer thickness of the rigid layer is a layer thickness subtracting a layer thickness of the interlayer from a layer thickness of the surface layer.

### (Hardness and Elasticity Modulus)

The elastic modulus of the invention can be measured by well-known measurement method of elastic modulus, for example, measuring by applying a constant strain under a constant frequency (Hz) by using Vibron DDV-2 manufactured by Orientec Co. Ltd., method by value obtained from changing applied strain under a constant frequency by using RSA-II manufactured by Rheometric Scientific after forming a layer on the transparent substrate, or nano indenter using nano indentation method such as Nano Indenter TMXP/DCM manufactured by MTS Systems Corporation. In the case of a very thin film like the present invention, nano indentation method is preferably used, from the stand point of high accurate measurement for elastic modulus of the layer.

It is preferable that hardness and elasticity modulus of a surface layer, an interlayer and a rigid layer, which are very thin layers, measured by nano indenter in view of high precision measurement in this invention.

Elasticity modulus a surface layer, an interlayer and a rigid layer of the intermediate transfer member is a value measured via a nanoindentation method in this invention.

Here, hardness and elasticity modulus of a rigid layer is measured directly, and, hardness and elasticity modulus of an interlayer is measured after removing a rigid layer by abrasion to expose an interlayer, via a nanoindentation method.

The method of measuring hardness with a nanoindentation method is a method of calculating plastic deformation hardness from the value obtained by measuring the relationship between a load and push-in depth (amount of displacement) while pushing a very small diamond indenter into a thin film.

It has characteristics that physical property of a resin substrate is hardly affected in a measurement of thin layer of not more than 1 μm particularly and, the crack is hardly generated in the thin layer at a time of indentation. It is generally used for a measurement of physical property of very thin layer.

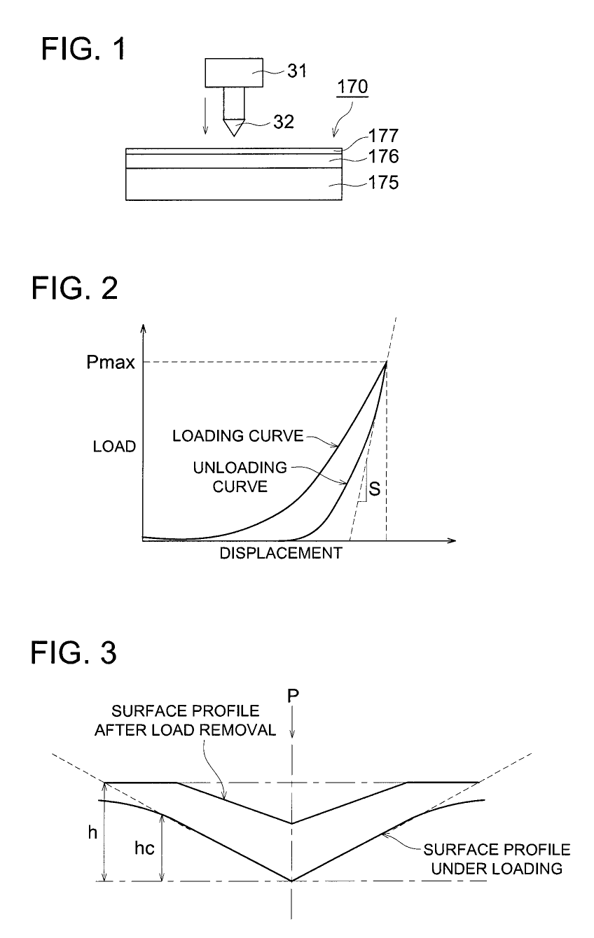

FIG. 1 is a schematic view showing an example of measuring device measuring hardness and elasticity modulus via a nanoindentation method.

In FIG. 1, 31 is a transducer, 32 diamond Berkovich indenter having an equilateral-triangular tip shape, 170 an intermediate transfer member, 175 a resin substrate, 176 an elastic layer, and 177 a surface layer.

The amount of displacement can be measured to an accuracy of nanometer while applying a load in μN by this measuring device, employing transducer 31 and diamond Berkovich indenter 32 having an equilateral-triangular tip shape. A commercially available “NANO Indenter XP/DCM” (manufactured by MTS Systems Corp., MTS NANO Instruments, Inc.) is usable for this measurement.

FIG. 2 shows a typical load-displacement curve obtained in the measurement of hardness and elasticity modulus via a nanoindentation method.

FIG. 3 is a diagram showing a contacting situation between an indenter and a sample.

Hardness H is determined from the following formula.

H=Pmax/A Formula (1)

wherein P is the maximum load, which is the load at which displacement reaches saturated point when load is applied to an indenter, and A is the contact projection area between the indenter and the sample.

Contact projection area A is expressed by the following Formula (2), employing h_{c} in FIG. 3.

A=24.5hc² Formula (2)

wherein h_{c}, expressed by the following Formula (3), is shallower than total push-in depth h because of elastic indentation of the periphery surface of a contact point as shown in FIG. 3.

hc=h−hs Formula (3)

wherein hₛ indicates an indentation amount caused by elasticity is expressed by the following formula (4), using a load curve slope after pushing in an indenter, i.e., slope S in FIG. 2, and an indenter shape.

hs=∈C:P/S Formula (4)

Here ∈ is a constant concerning the indenter shape to be 0.75 in the case of a Berkovich indenter.

Hardness and elasticity modulus of each layer of the inter layer can be measured employing a measuring device with such the nanoindentation method.

### Measure Condition

Apparatus: NANO Indenter XP/DCM (manufactured by MTS Systems Corp.)
Indenter: Diamond Berkovich indenter having an equilateral-triangular tip

### Circumstances: 20° C., 60% RH

Sample: An intermediate transfer member cut in size of 5 cm C: 5 cm
Maximum load: 25 μN
Pushing Speed: Speed to reach Maximum load 25 μN for 5 sec., wherein load is applied proportional to time.

Measurement was conducted at 10 points in each sample, and the average value is made as hardness measured via nanoindentation method.

A layer arrangement of the intermediate transfer member according to this invention will be described below.

The intermediate transfer member according to this invention is provided with an elastic layer on an outer periphery of the resin substrate, and further a surface layer thereon. Here, a surface layer may be composed of one or more rigid layers and one or more interlayers.

It may be a layer arrangement provided with a resin layer further on an elastic layer in this invention.

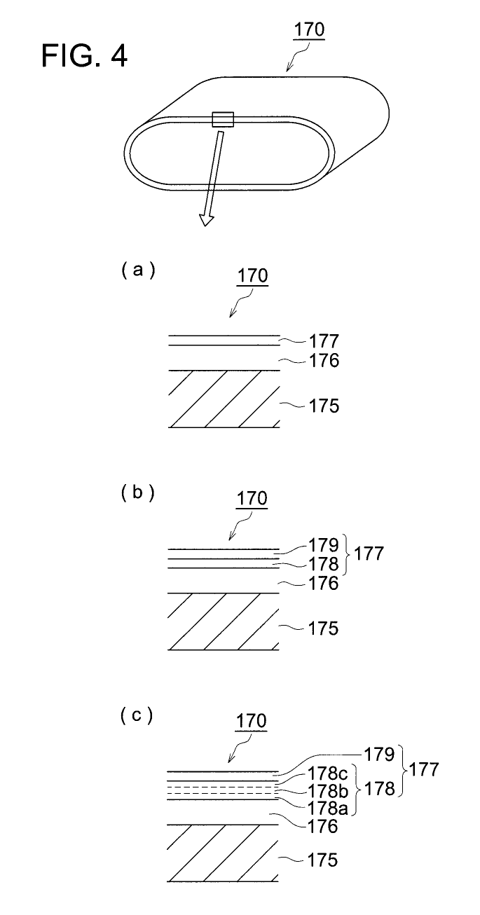

FIG. 4 shows a conceptual cross section drawing of an example of a layer arrangement of the intermediate transfer member.

In FIG. 4, 170 shows an intermediate transfer member, 175 a resin substrate, 176 an elastic layer, 177 a surface layer, 178 an interlayer, 178a a first layer of an interlayer, 178b a second layer of an interlayer, 178c a third layer of an interlayer, and 179 a rigid layer.

FIG. 4 (a) shows intermediate transfer member 170 having a layer arrangement provided with elastic layer 176 on periphery of the resin substrate and thereon a surface layer 177.

FIG. 4 (b) shows intermediate transfer member 170 having a layer arrangement provided with elastic layer 176 on periphery of the resin substrate, and thereon interlayer 178 and rigid layer 179 as surface layer 177.

FIG. 4 (c) shows intermediate transfer member 170 having a layer arrangement provided with elastic layer 176 on periphery of the resin substrate, and thereon three interlayers (178a, 178b, 178c) as surface layer 177, and further thereon a rigid layer 179.

The layer arrangement of the intermediate transfer member may be any one of FIG. 4 (a) or FIG. 4 (b).

Next, a resin substrate, an elastic layer and a surface layer are described.

### Resin Substrate

The resin substrate has stiffness which prevents deformation of intermediate transfer member due to load forced on the intermediate belt from cleaning member and reduces affects to transfer portion. A material of the resin substrate has elasticity modulus of in a range of 1.5 to 15.0 GPa measured via a nano indentation method.

A resin material exhibiting such performance includes, for example, polycarbonate, polyphenylene sulfide, polyethylene terephthalate, poly fluorinated vinylidene chloride, polyimide, polyether and etherketone, preferably polyimide, polycarbonate and polyphenylene sulfide among them.

The resin substrate according to this invention is preferably a seamless belt having a thickness of 50 to 200 μm and a drum having mechanical strength which have electrical resistivity (specific volume resistance) of 1 C: 10⁵ to 1 C: 10¹¹Ω·cm adjusted by adding an electrical conductivity giving agent to the resin material.

Carbon black can also be used as the conductive material. Neutral or acidic carbon black can be used as the carbon black. The conductive material may be added in such a way that volume resistance and surface resistance are in the predetermined range, depending on kinds of the employed conductive material, and usually 10 to 20 mass parts, preferably 10 to 16 mass parts based on 100 mass parts of resin material.

### (Elastic Layer)

The elastic layer is provided for the purpose of preventing generation of hollow defect in a letter image of the toner image by reducing concentration load to a toner image.

The elastic layer according to this invention may be composed of a rubber or an elastomer. It includes preferably a single or mixed compound of styrene-butadiene rubber, high styrene rubber, butadiene rubber, isoprene rubber, ethylene-propylene copolymer, nitrile butadiene rubber, chloroprene rubber, butyl rubber, silicone rubber, fluorine rubber, nitrile rubber, urethane rubber, acryl rubber, epichlorohydrin rubber and norbornane rubber, and can be formed by one of the elastic material.

Hardness of the elastic layer according to this invention is preferably 40° to 80° in terms of JIS A hardness. A layer thickness of the elastic layer is preferably 100 to 500 μm.

The elastic layer according to this invention is preferably a layer having an electrical resistivity (specific volume resistance) of 10⁵ to 10¹¹Ω·cm adjusted by dispersing an electrical conductivity giving agent in elastic material.

Conductive material to be added to the elastic layer includes carbon black, zinc oxide, tin oxide, silicon carbide and the like. Neutral or acidic carbon black can be used as the carbon black. The conductive material may be added in such a way that volume resistance and surface resistance are in the predetermined range, depending on kinds of the employed conductive material, and usually 10 to 20 mass parts, preferably 10 to 16 mass parts based on 100 mass parts of elastic material.

### (Surface Layer)

The surface layer is preferably a layer containing metal oxide, carbon containing-metal oxide or amorphous carbon.

A layer thickness of the surface layer is 100 to 1,000 nm, preferably 300 to 1,000 nm, and more preferably 500 to 1,000 nm. Herein total layer thickness of the interlayer and the rigid layer is preferably above described layer thickness when the surface layer is composed of the interlayer and the rigid layer.

Hardness of the surface layer is 0.1 to 10.0 GPa, and preferably 0.2 to 6.0 GPa.

Elasticity modulus of the surface layer is 0.5 to 50.0 GPa, and preferably 0.5 to 30.0 GPa.

Here, in case that a surface layer is composed of an interlayer and a rigid layer, it is preferably composed of a rigid layer comprising the interlayer and metal oxide described below as major components.

### (Interlayer)

The interlayer is provided for a purpose to prevent cracking or peeling from elastic layer of rigid layer.

The interlayer is formed by one or more layers.

The interlayer is preferably a layer composed of silicon oxide containing 1.0 to 20 atomic % of carbon atom as a major component, or an amorphous carbon layer. Further a layer composed of the mixture is also preferable.

A layer thickness of the interlayer is preferably 100 to 1,000 nm, more preferably 300 to 1,000 nm, and further preferably 500 to 1,000 nm.

Hardness of the interlayer is preferably 0.1 to 2.0 GPa, and more preferably 0.2 to 1.5 GPa.

Elasticity modulus of the interlayer is preferably 0.5 to 10.0 GPa, and more preferably 0.5 to 5.0 GPa.

The interlayer is a layer having lower hardness and lower elasticity modulus than a rigid layer. It may have a structure that the hardness and elasticity modulus increase from surface of the elastic layer to the rigid layer gradually. The embodiment of hardness and elasticity modulus increase gradually includes a multi-layer structure or a gradient structure.

Methods to form the interlayer are not restricted specifically, and can be formed by an atmospheric pressure plasma method applying two or more voltages of different frequency. Expected hardness and elasticity modulus can be attained by controlling output of applying electric power, controlling concentration of supplying raw material of atmospheric pressure plasma treatment and adjusting carbon atom content or layer density of the interlayer in case of forming by an atmospheric pressure plasma method adequately.

### (Rigid Layer)

The rigid layer is provided for the purpose of preventing generation of toner filming, ensuring high transfer performance, and inhibiting generation of wound due to a cleaning member.

A layer thickness of the rigid layer is preferably 0 to 50 nm, and more preferably 10 to 30 nm.

Hardness of the rigid layer is preferably 2.0 to 10.0 GPa, 2.0 to 6.0 GPa, and more preferably 2.0 to 5.0 GPa.

Elasticity modulus of rigid layer is preferably 10.0 to 50.0 GPa, more preferably 11.0 to 30.0 GPa, and further preferably 11.0 to 20.0 GPa.

The rigid layer is a layer composed of metal oxide as a major component. The metal oxide includes preferably metal oxide such as silicon oxide, silicon oxide nitride, silicon nitride, titanium oxide, titanium oxide nitride, titanium nitride or aluminum oxide, and silicon oxide layer is preferable among these.

It is preferable that the rigid layer of this invention is composed of one or more layers. It may have a structure in which hardness and elasticity modulus increases higher from a surface of the rigid layer toward the surface of the farthest rigid layer gradually, or density increases gradually.

An example of producing method of intermediate transfer member is described, however this invention is not limited thereto.

### (Resin Substrate)

A seamless belt composed of a resin material containing an electrical conductivity giving agent can be used as a resin substrate of the intermediate transfer member.

The resin substrate used in this invention can be manufactured by generally known methods. For example, materials of resin mixed with a conductivity giving agent are dissolved by an extruder, extruding via extrusion with a ring die or a T-die and rapidly cooled to prepare it.

The substrate may be subjected to such surface treatment as corona treatment, flame treatment, plasma treatment, glow discharge treatment, surface roughening treatment and chemical treatment prior to forming the elastic layer.

Further, primer layer may be formed between the surface layer and the substrate in order to improve adhesion. Primers used for the primer layer include a polyester resin, an isocyanate resin, a urethane resin, an acrylic resin, an ethylene vinyl alcohol resin, a vinyl-modified resin, an epoxy resin, a modified styrene resin, a modified silicon resin, alkyl titanate and so forth can be used singly or in combination with at least two kinds. A known additive can also be added into these primers. The above-described primer can be coated on a substrate employing a conventional method such as a roll coating method, a gravure coating method, a knife coating method, a dip coating method, a spray coating method or the like, and be primed by removing a solvent, a diluent and so forth via drying. The above-described primer preferably has a coating amount of 0.1-5 g/m² in a dry state.

### (Elastic Layer)

The elastic layer can be formed by the following way.

A resin substrate is put into in a vertical state of a tank containing coating liquid for the elastic layer and immersed. After forming coat layer of predetermined thickness is formed by immersing several times repeated and it is lift from the coating liquid. Next, after removing solvent by drying, it is subjected to thermal processing, for example, 60 to 150° C. for 60 minutes, and an elastic layer is produced.

### (Surface Layer)

The surface layer van be formed via plasma CVD method conducted at atmospheric pressure or its neighborhood (hereafter, referred to simply atmospheric pressure plasma CVD).

Hereafter, a forming apparatus and method via atmospheric pressure plasma CVD method as well as gas used therein are described.

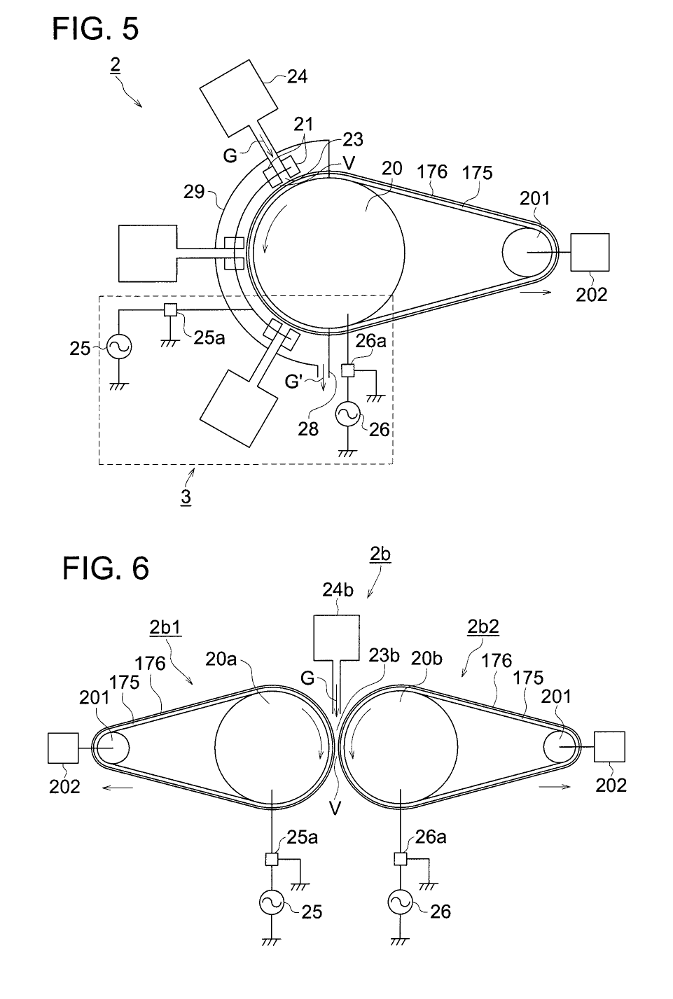

FIG. 5 shows an explanation drawing of the first manufacturing apparatus manufacturing a surface layer of the intermediate transfer member.

The first manufacturing apparatus forming the intermediate transfer member is a direct type in which the electric discharge space and the thin film depositing area are substantially identical, which forms surface layer 176 on substrate 175, includes: roll electrode 20 that rotatably supports substrate 175 of endless belt-shaped intermediate transfer member 170 and rotates in the arrow direction; driven roller 201; and atmospheric pressure plasma CVD device 3 which is a film-forming device to form surface layer 176 on the surface of substrate 175.

Atmospheric pressure plasma CVD device 3 includes: at least one set of fixed electrode 21 disposed along the outer circumference of roll electrode 20; electric discharge space 23 which is a facing region between fixed electrode 21 and roll electrode 20 where electric discharge is performed; mixed gas supply device 24 which produces mixed gas G of at least a raw material gas and a discharge gas to supply mixed gas G to discharge space 23; electric discharge container 29 which reduces air flow into, for example, discharge space 23; first power supply 25 connected to roll electrode 20; second power supply 26 connected to fixed electrode 21; and gas exhaustion section 28 for used exhausting gas G′.

Mixed gas supply device 24 supplies a mixed gas of a raw material gas and nitrogen gas or a rare gas such as argon gas, into the discharge space, in order to form a film having at least one layer selected from an inorganic oxide layer, an inorganic nitride layer and an inorganic carbide layer. Oxygen gas or hydrogen gas is preferably mixed to progress reaction by redox reaction.

Driven roller 201 is pulled in the arrow direction by tension-providing unit 202 and applies a predetermined tension to substrate. The tension-providing unit releases providing of tension, for example, during replacement of substrate, allowing easy replacement of substrate.

First power supply 25 provides a voltage of frequency ω1, second power supply 26 provides a voltage of frequency of ω2, and these voltages generate electric field V where frequencies ω1 and ω2 are superposed in discharge space 23. Electric field V makes mixed gas G at plasma state to deposit a film (an inter layer and a rigid layer) corresponding to the raw material gas contained in mixed gas G on the surface of substrate 176.

The surface layer may be deposited to form plural layers employing the mixed gas supply devices and the plural fixed electrodes disposed on the downstream side with respect to the rotation direction of the roll electrode, among the plural fixed electrodes, so as to adjust the thickness of inorganic layer.

An elastic layer 176 may be deposited employing the mixed gas supply devices and the fixed electrodes disposed on the downstream side with respect to the rotation direction of the roll electrode, among the plural fixed electrodes, while another layer, for example, a adhesive layer to improve adhesion between a surface layer and an elastic layer 176, may be formed by the other mixed gas supply devices and fixed electrodes disposed on the upper stream side.

Further, in order to improve adhesion between a surface layer and an elastic layer 176, gas supply devices to supply gas, such as argon gas or oxygen gas, and fixed electrodes may be arranged on the upstream side of the fixed electrodes and the mixed gas supply devices that form inorganic layer, so as to conduct a plasma treatment and thereby activating the surface of substrate.

As described above, an intermediate transfer belt being a seamless belt is tension-supported by a pair of rollers; one of the pair of rollers is used for one of a pair of electrodes; at least one fixed electrode as the other electrode is provided along the outer circumferential surface of the roller which works as the one electrode; an electric filed is generated between the pair of electrodes at an atmospheric pressure or an approximately atmospheric pressure to perform plasma discharge, so that a thin film is deposited and formed on the surface of the intermediate transfer member. Thus, it is possible to provide an intermediate transfer member exhibiting high transferability, high cleaning performance and high durability.

FIG. 6 is a schematic diagram of a second manufacturing apparatus to produce an inorganic layer of an intermediate transfer member.

Another manufacturing apparatus 2b for an intermediate transfer member forms an inorganic layer on each of plural substrates simultaneously, and mainly includes plural film-forming devices 2b1 and 2b2 each of which forms an inorganic layer on each of the substrate surfaces.

Second manufacturing apparatus 2b, which is modification of a direct type, that performs electric discharge between facing roll electrodes to deposit a thin film, includes: first film-forming device 2b1; second film-forming device 2b2 being disposed in a substantial mirror image relationship at a predetermined distance from first film-forming device 2b1; and mixed gas supply device 24b that produces mixed gas G of at least a raw material gas and a discharge gas to supply mixed gas G to electric discharge space 23b, mixed gas supply device 24b being disposed between first film-forming device 2b1 and second film-forming device 2b2.

First film-forming device 2b1 includes: roll electrode 20a and driven roller 201 that rotatably support a substrate 175 of a seamless belt shaped intermediate transfer member and rotate it in the arrow direction; tension-providing unit 202 that pulls the driven roller 201 in the arrow direction; and first power supply 25 connected to roll electrode 20a. Second film-forming device 2b2 includes: roll electrode 20b and driven roller 201 that rotatably support substrate 175 of an intermediate transfer member in an endless form and rotate it in the arrow direction; tension-providing unit 202 that pulls driven roller 201 in the arrow direction; and second power supply 26 connected to roll electrode 20b.

Further, second manufacturing apparatus 2b includes electric discharge space 23b where electric discharge is performed in a facing region between roll electrode 20a and roll electrode 20b.

Mixed gas supply device 24b supplies a mixed gas of a raw material gas, and nitrogen gas or a rare gas such as argon gas, into discharge space 23b, in order to form a film having at least one layer selected from an inorganic oxide layer, an inorganic nitride layer and an inorganic carbide film. It is further preferable to mix oxygen gas or hydrogen gas to accelerate reaction by redox reaction.

First power supply 25 provides a voltage of frequency col, second power supply 26 provides a voltage of frequency of ω2, and these voltages generate electric field V where frequencies ω1 and ω2 are superposed in discharge space 23b. Electric field V excites mixed gas G to make plasma (excited) state. Surfaces of an elastic layer 176 of the first film forming device 2b1 and surface of an elastic layer 176 of a second film forming device 2b2 are exposed to excited mixed gas as plasma state, so as to deposit and form layers (an interlayer or a rigid layer) corresponding to raw material gas contained in excited mixed gas are formed on a surface of an elastic layer 176 on a resin substrate 175 of the first film forming device 2b1 and a surface of an elastic layer 176 provided on a resin substrate 175 of a second film forming device 2b2 simultaneously.

Facing roll electrode 20a and roll electrode 20b are arranged at a predetermined distance between them.

Embodiments of the atmospheric pressure plasma CVD apparatus by which a surface layer is formed on an elastic layer 176 will be described.

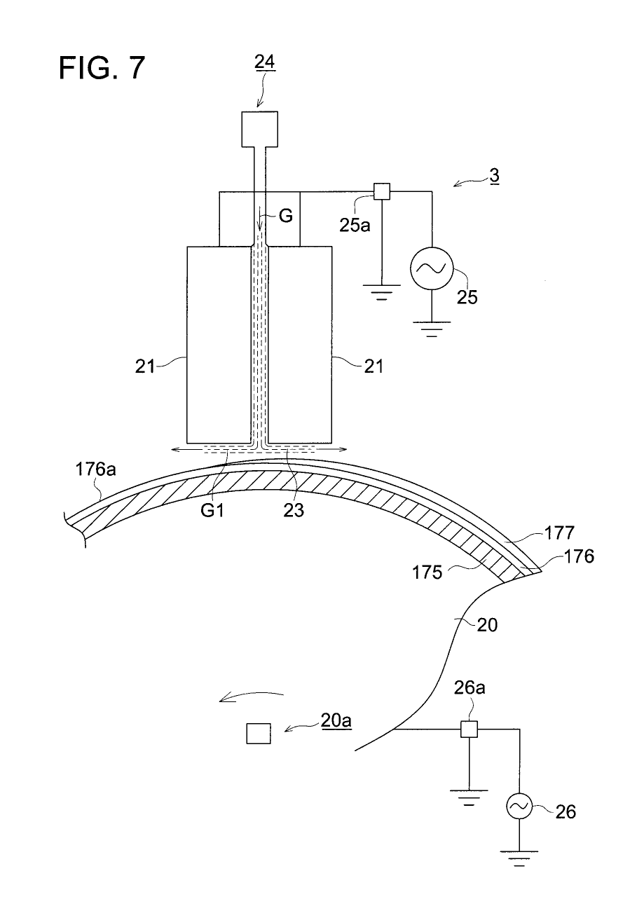

FIG. 7 is a partial view in which the dashed area in FIG. 5 is mainly extracted.

FIG. 7 is a schematic diagram of a first plasma film-forming apparatus to produce a surface layer of an intermediate transfer member employing plasma.

An example of an atmospheric pressure plasma CVD apparatus which is preferably used to form the surface layer 177 will be described, referring to FIG. 7.

Atmospheric pressure plasma CVD apparatus 3 includes at least one pair of rollers for rotatably supporting a substrate, which can be loaded and unloaded, and rotationally drive the substrate, and includes at least one pair of electrodes for performing plasma discharge, wherein one electrode of the pair of electrodes is one roller of the pair of rollers, and the other electrode is a fixed electrode facing the one roller through the substrate. It is an apparatus of manufacturing an intermediate transfer member and exposes the substrate to plasma generated in the facing area between the one roller and the fixed electrode so as to deposit and form the foregoing surface layer. It is preferably used in the case of employing nitrogen gas as discharge gas, for example, and applies a high voltage via one power supply, and applies a high frequency via another power supply so as to start discharging stably and perform discharge continuously.

Atmospheric pressure plasma CVD apparatus 3 includes mixed gas supply device 24, fixed electrode 21, first power supply 25, first filter 25a, roll electrode 20, drive unit 20a for rotationally driving the roll electrode in the arrow direction, second power supply 26, and second filter 26a, and performs plasma discharge in discharge space 23 to excite mixed gas G of a raw material gas with a discharge gas, and exposes substrate surface 176a to excited mixed gas G1 so as to deposit and form surface layer 177 on the substrate surface.

The first high frequency voltage of frequency of ω1 is applied to fixed electrode 21 from first power supply 25, and a high frequency voltage of frequency of ω2 is applied to roll electrode 20 from second power supply 26. Thus, an electric field is generated between fixed electrode 21 and role electrode 20 where frequency col at electric field intensity V₁ and frequency ω2 at electric field intensity V₂ are superposed. Current I₁ flows through fixed electrode 21, current I₂ flows through roll electrode 20, and plasma is generated between the electrodes.

The relationship between frequency ω1 and frequency ω2, and the relationship between electric field intensity V₁, electric field intensity V₂, and electric field intensity IV that initiates discharge of discharge gas satisfy ω1<ω2, and satisfy V₁≧IV>V₂ or V₁>IV≧V₂, wherein the output density of the second high frequency electric field is at least 1 W/cm².

It is preferable that at least electric field intensity V₁ applied from first power supply 25 is 3.7 kV/mm or higher, and electric field intensity V₂ applied from second high frequency power supply 60 is 3.7 kV/mm or lower, since electric field intensity IV to start electric discharge of nitrogen gas is 3.7 kV/mm.

As the first power supply 25 (high frequency power supply) applicable to first atmospheric pressure plasma CVD apparatus 3, any of the following commercially available power supplies can be used.

| Applied | | | | |
|---|---|---|---|---|
| Power | | | | |
| supply | Manufacturer | Frequency | | Product name |
| A1 | Shinko Electric Co., Ltd. | 3 | kHz | SPG3-4500 |
| A2 | Shinko Electric Co., Ltd. | 5 | kHz | SPG5-4500 |
| A3 | Kasuga Electric Works, Ltd. | 15 | kHz | AGI-023 |
| A4 | Shinko Electric Co., Ltd. | 50 | kHz | SPG50-4500 |
| A5 | Haiden Laboratory | 100 | kHz* | PHF-6k |
| A6 | Pearl Kogyo Co., Ltd. | 200 | kHz | CF-2000-200k |
| A7 | Pearl Kogyo Co., Ltd. | 400 | kHz | CF-2000-400k |
| A8 | SEREN IPS | 100-460 | kHz | L3001 |

As the second power supply 26 (high frequency power supply), any of the following commercially available power supplies can be used.

| Applied | | | | |
|---|---|---|---|---|
| Power | | | | |
| supply | Manufacturer | Frequency | | Product name |
| B1 | Pearl Kogyo Co., Ltd. | 800 | kHz | CF-2000-800k |
| B2 | Pearl Kogyo Co., Ltd. | 2 | MHz | CF-2000-2M |
| B3 | Pearl Kogyo Co., Ltd. | 13.56 | MHz | CF-5000-13M |
| B4 | Pearl Kogyo Co., Ltd. | 27 | MHz | CF-2000-27M |
| B5 | Pearl Kogyo Co., Ltd. | 150 | MHz | CF-2000-150M |
| B6 | Pearl Kogyo Co., Ltd. | 22-99.9 | MHz | RP-2000-20/100M |

Regarding the above described power supplies, the power supply marked * is an impulse high frequency power supply of Haiden Laboratory (100 kHz in continuous mode). High frequency power supplies other than the power supply marked * are capable of applying only continuous sine waves.

Regarding the power supplied between the facing electrodes from the first and second power supplies, a power (output density) of at least 1 W/cm² is supplied to fixed electrode 21 so as to excite discharge gas, and plasma is generated to form a thin film. The upper limit of the power to be supplied to fixed electrode 21 is preferably 50 W/cm², and more preferably 20 W/cm². The lower limit is preferably 1.2 W/cm². Herein, the discharge area (cm²) means the area of the range where discharge is generated at the electrode.

The output density can be improved while maintaining uniformity of the high frequency electric field by supplying roll electrode 20 with a power (output density) of at least 1 W/cm². Thus, plasma with highly even density can be generated, which improves both a film-forming rate and film quality. The power is preferably at least 5 W/cm². The upper limit of the power to be supplied to roll electrode 20 is preferably 50 W/cm².

Herein, waveforms of high frequency electric fields are not specifically limited, and can be in continuous oscillation mode of a continuous sine wave form called a continuous mode, and also in intermittent oscillation mode called a pulse mode performing ON/OFF intermittently, either of which may be employed. However, at least, the high frequency to be supplied to roll electrode 20 preferably has a continuous sine wave to obtain a dense film exhibiting good quality.

First filter 25a is provided between fixed electrode 21 and first power supply 25 to allow a current to flow easily from first power supply 25 to fixed electrode 21, and the current from second power supply 26 is grounded to inhibit a current running from second power supply 26 to first power supply 25. Second filter 26a is provided between roll electrode 20 and second power supply 26 to allow a current to flow easily from second power supply 26 to roll electrode 20, and the current from first power supply 21 is grounded to inhibit a current running from first power supply 25 to second power supply 26.

It is preferable to employ electrodes capable of applying a high electric field, and maintaining a uniform and stable discharge state. For durability against discharge by a high electric field, the dielectric material described below is coated on at least one surface of each of fixed electrode 21 and roll electrode 20.

In the above description, regarding the relationship between the electrode and the power supply, second power supply 26 may be connected to fixed electrode 21, and first power supply 25 may be connected to roll electrode 20.

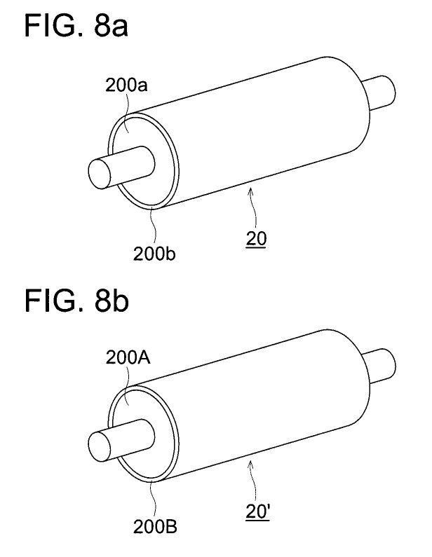

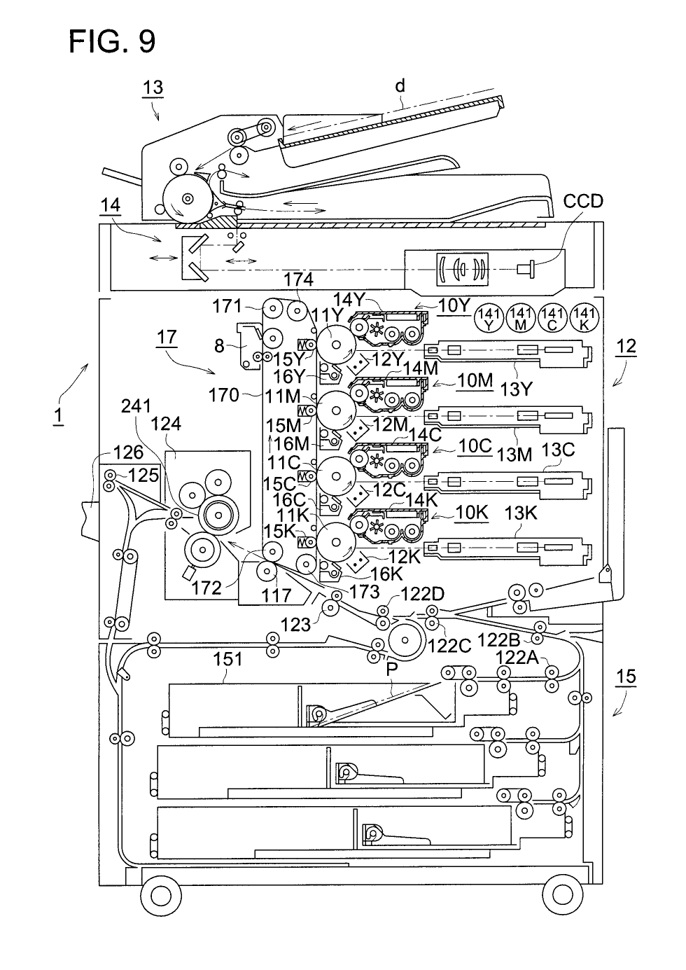

FIG. 8 is a schematic diagram showing an example of the roll electrode.

The structure of roll electrode 20 will be described below. As shown in FIG. 8(a), roll electrode 20 is constructed with conductive base material 200a (hereinafter, referred to also as “electrode base material”) made of metal or the like, onto which ceramic-coated dielectric material 200b (hereinafter, also referred to simply as “dielectric material”) which has been subjected to a sealing treatment with an inorganic material after thermally spraying is coated. As the ceramic material to be used for spraying, alumina, silicon nitride or the like is preferably used, but alumina is specifically preferable in view of easy workability.

Further, as shown in FIG. 8(b), roll electrode 20′ may be constructed with conductive base material 200A made of metal or the like onto which lining-treated dielectric material 200B fitted with an inorganic material by lining is coated. As the lining material, silicate glass, borate glass, phosphate glass, germinate glass, tellurite glass, aluminate glass, vanadate glass or the like is preferably used, but borate glass is specifically preferable in view of easy workability.

Examples of conductive base materials 200a and 200A made of metal or the like include silver, platinum, stainless steel, aluminum, titanium, iron and so forth, but stainless steel is preferable in view of easy workability.

In the present embodiment, a stainless-steel jacket-roll base material (not shown) fitted with a cooling device by using cooling water is employed for base materials 200a and 200A of the roll electrodes.

An example of a process forming a surface layer 177 by deposition on an elastic layer 176 formed on a resin substrate 175 among the manufacturing process of intermediate transfer member is described by referring to FIGS. 5 and 7 below.

In FIGS. 5 and 7, after a resin substrate 175 is tension-supported by roll electrode 20 and driven roller 201, predetermined tension is applied to a resin substrate 175 by an action of tension-giving means 202, then roll electrode 20 is rotationally driven with predetermined rotational frequency. Driven roller 201 is pulled in the arrow direction by tension-providing unit 202 and applies a predetermined tension to substrate.

Mixed gas G is generated from mixed gas supplying device 24 and discharged into discharge space 23.

First power supply 25 provides a voltage of frequency ω1, second power supply 26 provides a voltage of frequency of ω2, and these voltages generate electric field V where frequencies ω1 and ω2 are superposed in discharge space 23.

Mixed gas G discharge into discharge space 23 is excited by electric field to make plasma state. An elastic layer surface is exposed to plasma state mixed gas G, and at least one layer selected from an inorganic oxide layer, an inorganic nitride layer and an inorganic carbide layer, i.e., a surface layer 177 is formed on an elastic layer 176 by raw material gas in the mixed gas G.

A discharge gas refers to a gas being plasma-excited in the above described conditions, and can be nitrogen, argon, helium, neon, krypton, xenon or a mixture thereof. Nitrogen, helium and argon are preferably used among them and nitrogen is preferable because of low cost.

### (Raw Material Gas)

As a raw material gas to form a surface layer, an organometallic gas being in a gas or liquid state at room temperature is used, and an alkyl metal compound, a metal alkoxide compound and an organometallic complex compound are specifically used. The phase state of these raw materials is not necessarily a gas phase at normal temperature and pressure. A raw material capable of being vaporized through melting, evaporating, sublimation or the like via heating or reduced pressure with mixed gas supply device 24 can be used either in a liquid phase or solid phase.

The raw material gas is one being in a plasma state in discharge space and containing a component to form a thin film, and is an organometallic compound, an organic compound, an inorganic compound or the like.

Examples of silicon compounds include silane, tetramethoxysilane, tetraethoxysilane (TEOS), tetra-n-propoxysilane, tetra-iso-propoxysilane, tetra-n-butoxysilane, tetra-t-butoxysilane, dimethyldimethoxysilane, dimethyldiethoxysilane, diethyldimethoxysilane, diphenyldimethoxysilane, methyltriethoxysilane, ethyltrimethoxysilane, phenyltriethoxysilane, (3,3,3-trifluoropropyl)trimethoxysilane, hexamethyldisiloxane, bis(dimethylamino)dimethylsilane, bis(dimethylamino)methylvinylsilane, bis(ethylamino)dimethylsilane, N,O-bis(trimethylsilyl)acetamide, bis(trimethylsilyl)carbodiimide, diethylaminotrimethylsilane, dimethylaminodimethylsilane, hexamethyldisilazane, heaxamethylcyclotrisilazane, heptamethylsilazane, nonamethyltrisilazane, octamethylcyclotetrasilazane, tetrakisdimethylaminosilane, tetraisocyanatesilane, tetramethyldisilazane, tris(dimethylamino)silane, triethoxyfluorosilane, allyldimethylsilane, allyltrimethylsilane, benzyltrimethylsilane, bis(trimethylsilyl)acetylene, 1,4-bistrimethylsilyl-1,3-butadiine, di-t-butylsilane, 1,3-disilabutane, bis(trimethylsilyl)methane, cyclopentadiphenyltrimethylsilane, phenyldimethylsilane, phenyltrimethylsilane, propargyl trimethylsilane, tetramethylsilane, trimethylsilylacetylene, 1-(trimethylsilyl)-1-propine, tris(trimethylsilyl)methane, tris(trimethylsilyl)silane, vinyltrimethylsilane, hexamethyldisilane, octamethylcyclotetrasiloxane, tetramethylcyclotetrasiloxane, hexamethylcyclotetrasiloxane and M-silicate 51, but are not limited thereto.

Examples of titanium compounds include organometallic compounds such as tetradimethylamino titanium and so forth; metal hydrogen compounds such as monotitanium, dititanium and so forth; metal halogenated compounds such as titanium dichloride, titanium trichloride, titanium tetrachloride and so forth; and metal alkoxides such as tetraethoxy titanium, tetraisopropoxy titanium, tetrabutoxy titanium and so forth, but are not limited thereto.

Examples of aluminum compounds include aluminum n-butoxide, aluminum s-butoxide, aluminum t-butoxide, aluminum diisopropoxide ethyl aceto acetate, aluminum ethoxide, aluminum hexafluoropentanedionato, aluminum isopropoxide, aluminum 4-pentanedionato, dimethyl aluminum chloride and so forth, but are not limited thereto.

Further, the above-described raw material may be used singly, or by mixing components of at least two kinds.

### (Additional Gas)

An additional gas is used for the purpose of controlling component during layer formation, hardness and elasticity modulus, and layer density in this invention.

The additional gas includes oxygen, hydrogen and carbon dioxide. For example, when hydrogen is used as the additional gas carbon containing layer is formed easily and when oxygen is used metal oxide layer is formed easily.

Hardness and elasticity modulus of the surface layer can be controlled by layer forming rate, raw material gas as used, kind of additional gas, content ratio of each gas and the like.

An interlayer containing carbon atoms in a layer can be obtained by that mixed gas (discharge gas) is plasma excited between a pair of electrodes (roll electrode 20 and fixed electrode 21), and raw material gas containing carbon atom in the plasma is made radical and expose to a surface of elastic layer 176 in above described atmospheric pressure plasma CVD device 3. And carbon containing molecule or carbon containing radical exposed to surface of elastic layer 176 is incorporated in an interlayer.

As raw material gas for forming amorphous carbon layer (a layer composed of amorphous carbon as major component), gas of an organic compound in gas or liquid state at normal temperature, in particular hydrocarbon gas is used. The phase state of the raw material at normal temperature and normal pressure is not necessarily gas phase, and anything in liquid or solid state can be used as far as it can be made gas through fusion, vaporization, sublimation and the like by heating or reducing pressure in mixed gas supplying device 24. Usable gas as hydrocarbon gas as the raw material gas include any gas containing at least hydrocarbon, for example, paraffin series hydrocarbon such as CH₄, C₂H₆, C₃H₈ and C₄H₁₀, acetylene series hydrocarbon such as C₂H₂ and C₂H₄, olefin series hydrocarbon, diolefin series hydrocarbon, and further aromatic hydrocarbon. Further, a compound containing carbon atom such as alcohols, ketones, ethers, esters, CO and CO₂, in addition to hydrocarbon can be usable.

Further, the raw material gas may be used singly or mixture of two or more kinds.

Next, an image forming method and an image forming apparatus using the intermediate transfer member of this invention is described.

### <<Image Forming Method, Image Forming Apparatus>>

The intermediate transfer medium according to this invention may be applied to an image forming apparatus such as an electrophotographic copying machine, printer and facsimile suitably.

An image forming apparatus in which intermediate transfer member of this invention can be used is described referring to a color image forming apparatus as an example.

FIG. 10 is a cross-sectional schematic view of an example of a color image forming apparatus.

Color image forming apparatus 1 is called a tandem type full-color copier, and is comprised of automatic document conveying device 13, original document reading device 14, plural exposure units 13Y, 13M, 13C and 13K, plural image forming sections 10Y, 10M, 10C and 10K, intermediate transfer member unit 17, sheet feeding unit 15 and fixing device 124.

Around the upper portion of main body 12 of the image forming apparatus, disposed are automatic document conveying device 13 and original document reading device 14. An image of original document d conveyed by automatic document conveying device 13 is reflected and caused to form an image by an optical system of image reading device 14, and the image is read by line image sensor CCD.

An analog signal produced by photoelectric conversion of an image of an original document read by the line image sensor CCD is subjected, in an image processing section (not shown), to analog processing, A/D conversion, shading calibration, image compression processing and the like, thereafter transmitted to exposure units 13Y, 13M, 13C and 13K as digital image data of the respective colors, and then latent images of the image data of the respective colors are formed by exposure units 13Y, 13M, 13C and 13K on photoreceptors 11Y, 11M, 11C and 11K in the form of drum.

Image forming members 10Y, 10M, 10C, 10K are arranged in tandem in the vertical direction. An intermediate transfer member of this invention (referred also to intermediate transfer belt hereafter) 170, which is the second image carrier of semi-conductive seamless belt, is arranged at left side of photoreceptors 11Y, 11M, 11C, 11K in the drawing photoreceptor rotatably tension-supported through rollers 171, 172, 173, 174.

Intermediate transfer belt 170 of the present invention is driven along the arrow direction through roller 171 which is rotationally driven by a drive unit (not shown).

Image forming section 10Y for forming yellow color images includes charging unit 12Y, exposure unit 13Y, development unit 14Y, primary transfer roller 15Y, and cleaning unit 16Y which are disposed around photoreceptor 11Y.

Image forming section 10M for forming magenta color images includes photoreceptor 11M, charging unit 12M, exposure unit 13M, development unit 14M, primary transfer roller 15M, and cleaning unit 16M.

Image forming section 10C for forming cyan color images includes photoreceptor 11C, charging unit 12C, exposure unit 13C, development unit 14C, primary transfer roller 15C, and cleaning unit 16C.

Image forming section 10K for forming black color images includes photoreceptor 11K, charging unit 12K, exposure unit 13K, development unit 14K, primary transfer roller 15K, and cleaning unit 16K.

Toner supply units 141Y, 141M, 141C and 141K supply new toner to respective development units 14Y, 14M, 14C and 14K.

Primary transfer rollers 15Y, 15M, 15C and 15K are selectively operated by a control unit (not shown) corresponding to the image type, and press intermediate transfer belt 170 against respective photoreceptors 11Y, 11M, 11C and 11K to transfer images on the photoreceptors.

In such a manner, the images in the respective colors formed on photoreceptors 11Y, 11M, 11C and 11K by image forming sections 10Y, 10M, 10C and 10K are sequentially transferred to circulating intermediate transfer belt 170 by primary transfer rollers 15Y, 15M, 15C and 15K so that synthesized color images are formed.

The toner images carried on the surfaces of the photoreceptors are first transferred to the surface of the intermediate transfer belt, and the intermediate transfer belt holds the transferred toner image.

Transfer material P as a recording medium stored in sheet supply cassette 151 is fed by sheet feeding unit 151, then conveyed into second transfer roller 117 through plural intermediate rollers 122A, 122B, 122C, 122D and registration roller 123, and then the synthesized toner image on the intermediate transfer member is transferred all together onto transfer material P by second transfer roller 117.

The toner image held on the intermediate transfer member is secondarily transferred onto the surface of the transfer material.

Transfer material P onto which the color image has been transferred is subjected to a fixing treatment by fixing device 124, and nipped by sheet-ejection rollers 125 to be loaded on sheet-ejection tray 126 equipped outside the apparatus.

on intermediate transfer belt 170 having curvature-separated recording sheet P is removed by cleaning unit 8, after the color image is transferred to recording medium P by second transfer roller 117.

Herein, the intermediate transfer member may be replaced by a rotatable intermediate transfer drum as described above.

Next, the structure of primary transfer rollers 15Y, 15M, 15C and 15K as first transfer units being in contact with intermediate transfer belt 170, and the structure of second transfer roller 117 will be described.

Primary transfer rollers 15Y, 15M, 15C and 15K are formed, for example, by coating the circumferential surface of a conductive core metal of stainless or the like with an outer diameter of 8 mm, with a semiconductive elastic rubber having a thickness of 5 mm and rubber hardness in an approximate range of 20-70 degrees (Asker hardness C).

Second transfer roller 117 is formed, for example, by coating a circumferential surface of a conductive core metal of stainless steel or the like with an outer diameter of 8 mm, with a semiconductive elastic rubber having a thickness of 5 mm and a rubber elasticity modulus in an approximate range from 20 to 70 degrees (Asker hardness C). The semiconductive elastic rubber is prepared by making a rubber material, such as polyurethane, EPDM, silicon or the like into a solid state or foam sponge state with a volume resistance in an approximate range of 10⁵-10⁹Ω·cm, dispersing conductive filler such as carbon, to the rubber material or having the rubber material contain an ionic conductive material.

### <Transfer Material>

Transfer material used in this invention is a support to hold toner image, and is usually called as an image support material, a transfer material or transferee paper. Specifically it includes usual paper having various thicknesses, coated printing paper such as art paper or coated paper, Japanese paper or post card on the market, plastic film such as OHP sheet and textile, but not limited thereto.

### EXAMPLE

The invention is described concretely by referring to working example, however it is not limited thereto.

[symbol]

Producing Intermediate Transfer Member

[symbol]

Intermediate transfer members of a sample of the invention and a sample of comparison were manufactured by the following procedure.

### <Preparation of Resin Substrate>

### (Preparation of Resin Substrate 1)

A seamless belt composed of polyphenylene-sulfide (PPS) containing an electrical conductivity giving agent having a thickness of 100 μm was prepared and was named as “resin substrate 1”.

### <Producing Intermediate Transfer Member 1>

### (Producing Elastic Layer 1)

On the outer periphery of prepared as described above “a resin substrate 1”, “elastic layer 1” composed of chloroprene rubber having thickness of 150 μm was provided by dip coating method.

### (Producing Interlayer 1)

Next, “an interlayer 1” was formed on the above described “elastic layer 1” by employing plasma discharge treatment device of FIG. 5.

The interlayer mixed gas composition described below was used for the material of the interlayer 1. The interlayer 1 was formed in the layer forming condition described below. As the dielectric covering each electrode fitted into the plasma discharge treatment apparatus in this case, alumina of a thickness of 1 mm was coated on each of both facing electrodes via thermally sprayed ceramic treatment. The spacing between the electrodes was set to 1 mm. A metal base material on which a dielectric was coated was prepared in accordance to the stainless steel jacket specification having a cooling function with cooling water, and the plasma discharge treatment was conducted while controlling electrode temperature with cooling water during discharging, and “interlayer 1” (SiₓO_{y}) was manufactured.

(Interlayer Mixed Gas Composition)

| | | |
|---|---|---|
| Discharge gas: Nitrogen gas | 94.85% | by volume |
| Layer forming (raw material) | 0.15% | by volume |
| gas: hexamethyldisiloxane | | |
| Additional gas: Oxygen gas | 5.00% | by volume |

Each raw material gas was heated to generate vapor, and was supplied to discharge space after mixing with discharge gas and reaction gas which were heated preliminarily for preventing aggregation of raw material, and diluting.

### (Interlayer Forming Condition)

### The First Electrode Side Power Supply

PHF-6 k, product by Haiden Laboratory, high frequency power supply 100 kHz (continuous mode)
Frequency: 100 kHz
Power density: 10 W/cm² (Voltage Vp: 7 kV)
Electrode temperature: 70° C.

### The Second Electrode Side Power Supply

CF-5000-13M, product by Pearl Kogyo Co., Ltd., high frequency power supply 13.56 MHz
Frequency: 13.56 MHz
Power density: 5 W/cm² (Voltage Vp: 1 kV)
Electrode temperature: 70° C.

### (Producing Rigid Layer 1)

Next, “rigid layer 1” was formed on the above described “interlayer 1” by employing an atmospheric pressure plasma CVD device of FIG. 5.

Rigid layer mixed gas composition described below was used for the rigid layer forming material. The rigid layer was formed in the layer forming condition described below. As the dielectric covering each electrode fitted into the plasma discharge treatment apparatus in this case, alumina of a thickness of 1 mm was coated on each of both facing electrodes via thermally sprayed ceramic treatment. The spacing between the electrodes was set to 1 mm. A metal base material on which a dielectric was coated was prepared in accordance to the stainless steel jacket specification having a cooling function with cooling water, and the plasma discharge treatment was conducted while controlling electrode temperature with cooling water during discharging, and “rigid layer 1” (SiO₂) was manufactured.

(Rigid layer mixed gas composition)

| | | |
|---|---|---|
| Discharge gas: Nitrogen gas | 94.99% | by volume |
| Layer forming (raw material) | 0.01% | by volume |
| gas: tetraethoxysilane (TEOS) | | |
| Additional gas: Oxygen gas | 5.00% | by volume |

Each raw material gas was heated to generate vapor, and was supplied to discharge space after mixing with discharge gas and reaction gas which were heated preliminarily for preventing aggregation of raw material, and diluting.

### (Rigid Layer Forming Condition)

### The First Electrode Side Power Supply

PHF-6 k, product by Haiden Laboratory, high frequency power supply 100 kHz (continuous mode)
Frequency: 100 kHz
Power density: 10 W/cm² (Voltage Vp: 7 kV)
Electrode temperature: 70° C.

### The Second Electrode Side Power Supply

CF-5000-13M, product by Pearl Kogyo Co., Ltd., high frequency power supply 13.56 MHz
Frequency: 13.56 MHz
Power density: 10 W/cm² (Voltage Vp: 2 kV)
Electrode temperature: 70° C.

### <Producing Intermediate Transfer Members 2 to 15, 17 to 21, 25 and 26>

“intermediate transfer member 2 to 15, 17 to 21, 25, 26” were produced in the same manner as producing process of intermediate transfer member 1, except that forming condition of interlayer 1 and producing condition of rigid layer 1 were modified so as to satisfy the layer thickness, hardness and elasticity modulus described in Table 1.

### <Producing Intermediate Transfer Member 16>

“Intermediate transfer member 16” was produced in the same manner as producing interlayer 1, except that only a rigid layer was formed without forming an interlayer.

### <Producing Intermediate Transfer Member 22 to 24, 27>

“Intermediate transfer members 22 to 24, 27” were produced in the same manner as producing interlayer 1, except that only an interlayer was formed without forming a rigid layer.

The layer thickness, hardness and elasticity modulus of the interlayer, and the layer thickness, hardness and elasticity modulus of the rigid layer of the above described intermediate transfer members are shown in Table 1.

TABLE 1

| | Interlayer | | | Rigid Layer | | |
|---|---|---|---|---|---|---|
| Intermediate | Layer | | Elasticity | Layer | | Elasticity |
| transfer member | thickness | Hardness | modulus | thickness | Hardness | modulus |
| No. | (nm) | (GPa) | (GPa) | (nm) | (GPa) | (GPa) |
| 1 | 100 | 0.4 | 2 | 50 | 5 | 25 |
| 2 | 100 | 0.7 | 3.5 | 50 | 3 | 15 |
| 3 | 100 | 1 | 5 | 10 | 2.4 | 12 |
| 4 | 300 | 0.4 | 2 | 50 | 2.4 | 12 |
| 5 | 300 | 0.7 | 3.5 | 10 | 5 | 25 |
| 6 | 300 | 1 | 5 | 50 | 3 | 15 |
| 7 | 600 | 0.4 | 2 | 10 | 3 | 15 |
| 8 | 600 | 0.7 | 3.5 | 50 | 2.4 | 12 |
| 9 | 600 | 1 | 5 | 10 | 5 | 25 |
| 10 | 1000 | 1 | 5 | 30 | 3 | 15 |
| 11 | 80 | 1 | 5 | 30 | 3 | 15 |
| 12 | 1200 | 1 | 5 | 30 | 3 | 15 |
| 13 | 600 | 0.1 | 0.5 | 30 | 3 | 15 |
| 14 | 600 | 2 | 10 | 30 | 3 | 15 |
| 15 | 600 | 3 | 15 | 30 | 3 | 15 |
| 16 | — | — | — | 30 | 3 | 15 |
| 17 | 600 | 1 | 5 | 5 | 3 | 15 |
| 18 | 600 | 1 | 5 | 100 | 3 | 15 |
| 19 | 600 | 1 | 5 | 30 | 2 | 10 |
| 20 | 600 | 1 | 5 | 30 | 10 | 50 |
| 21 | 600 | 1 | 5 | 30 | 12 | 60 |
| 22 | 600 | 1 | 5 | — | — | — |
| 23 | 50 | 1 | 5 | — | — | — |
| 24 | 1200 | 1 | 5 | — | — | — |
| 25 | 1200 | 5 | 25 | 5 | 1 | 5 |
| 26 | 80 | 0.1 | 0.5 | 100 | 12 | 60 |
| 27 | 600 | 0.01 | 0.05 | — | — | — |

Here, a layer thickness and elasticity modulus were measured in a method described above.

### (Evaluation)

### <Image Forming Apparatus>

Evaluation of the intermediate transfer members manufactured as described above were conducted by installing into an image forming apparatus bizhub PRO C6500 product by Konica Business Technologies Inc.

Two component developer composed of a toner having volume based median particle diameter (D₅₀) of 4.5 μm and a coated carrier having 60 μm was employed for the image forming.

Test printing was conducted in environmental conditions of low temperature and low humidity (10° C., 20% RH) and high temperature and high humidity (33° C., 80% RH). A4-size high quality paper (64 g/m²) was employed for the transferee.

A4-size original having four quarter images comprising a character image having pixel ratio of 7% and 3-point and 5-point characters, a color portrait image (dot images including half tone) white solid image and black solid image was employed for the print test.

### (Evaluation)

### (Generation of Cracks)

Generation of cracks was evaluated by such a way that in an ordinary temperature and moisture environment (20° C., 50% RH), intermediate transfer member was extended around the round bars having different diameter at a resin substrate side (a back sides) of the intermediate transfer member, and generation of cracks on the surface of surface layer of the intermediate transfer member was observed via a microscope. Level 1 and Level 2 are acceptable.

Level 1: Crack does not generate by 15 mm diameter bar

Level 2: Crack generates by 15 mm diameter bar, and Crack does not generate by 25 mm diameter bar

Level 3: Crack generates by 25 mm diameter bar, and Crack does not generate by 45 mm diameter bar

Level 4: Crack generates by 45 mm diameter bar

Level 5: Crack generates on a plane

### (Cleaning Performance)

Cleaning performance was evaluated by that prints were made at low temperature and low humidity environmental condition (10° C., 20% RH), then surface of the intermediate transfer member subjected to cleaning with blade was visually observed, and a degree of remaining toner on the surface was evaluated. Degree of generation of image stain on the print image due to cleaning defect was also evaluated.

### Evaluation Criteria

A: Remaining toner on the intermediate transfer member after cleaning was not observed and image stain due to cleaning defect on the print image was not observed, up to 160 thousandth prints.

B: Remaining toner on the intermediate transfer member after cleaning was observed however image stain due to cleaning defect on the print image was not observed, at 160 thousandth prints.

C: Remaining toner on the intermediate transfer member after cleaning was observed and image stain due to cleaning defect on the print image was observed, at 100 thousandth prints, the print was not practically acceptable.

### (Image Defects Due to Crack)

Evaluation of the image defects due to crack was conducted in such a way that after 160 thousand sheets printing in environmental conditions of low temperature and low humidity (10° C., 20% RH), degree of crack generation and degree of image defects due to crack generation in the obtained prints were evaluated by visually observation of surface of the intermediate transfer member.

### Evaluation Criteria

A: No generation of crack on intermediate transfer member surface is observed, and no image defects due to crack is observed

B: Slight crack is observed on intermediate transfer member surface, however no image defects due to crack is observed

C: Crack expands and growths on intermediate transfer member surface, image defects due to crack is observed, and there is practical problem

### (Toner Filming)

Evaluation of the toner filming was conducted in such a way that after 160 thousand sheets printing in environmental conditions of low temperature and low humidity (10° C., 20% RH), degree of toner filming generation and degree of fog and white streaks generated in the 160 thousandth sheet print were evaluated by visually observation of surface of the intermediate transfer member.

### Evaluation Criteria

A: Uneven glossiness due to toner filming on intermediate transfer member surface is not observed at all, and fog or white streaks do not generate in the print image due to toner filming

B: Uneven glossiness due to toner filming on intermediate transfer member surface is observed slightly, or fog or white streaks do not generate in the corresponding portion of the print image

C: Uneven glossiness due to toner filming on intermediate transfer member surface is observed, and fog or white streaks generate in the corresponding portion of the print image toner filming

### (Durability)

Evaluation of the durability was conducted by an image density of the after completion of 160 thousand sheets printing in environmental conditions of 1 high temperature and high humidity (33° C., 80% RH).

Image density was evaluated by measuring density at 12 points of solid black image portion via a reflective densitometer “RD-918” (product by Gretag Macbeth GMB)

### Evaluation Criteria

A: Image density of not less than 1.35, excellent

B: Image density of not less than 1.20 and not more than 1.35, a level of practically no problem

C: Image density of not more than 1.2, a level of practically problem

Layer thickness and evaluation results of the surface layer are shown in Table 2.

TABLE 2

| | Intermediate | Thickness | | | Image | | |
|---|---|---|---|---|---|---|---|
| | transfer | of surface | Crack | Cleaning | defect due | Toner | |
| Sample | member No. | layer (nm) | generation | performance | to crack | filming | Durability |
| Example 1 | 1 | 150 | 2 | B | B | B | A |
| Example 2 | 2 | 150 | 2 | B | B | B | B |
| Example 3 | 3 | 110 | 1 | B | A | A | B |
| Example 4 | 4 | 350 | 1 | B | A | A | B |
| Example 5 | 5 | 310 | 2 | B | A | A | A |
| Example 6 | 6 | 350 | 2 | B | B | B | B |
| Example 7 | 7 | 610 | 1 | B | A | A | B |
| Example 8 | 8 | 650 | 1 | B | B | B | B |
| Example 9 | 9 | 610 | 2 | B | B | B | A |
| Comparative | 10 | 1030 | 2 | B | B | C | B |
| Example 1 | | | | | | | |
| Comparative | 11 | 110 | 3 | B | C | C | C |
| Example 2 | | | | | | | |
| Comparative | 12 | 1230 | 3 | B | B | C | B |
| Example 3 | | | | | | | |
| Example 10 | 13 | 630 | 1 | B | A | B | B |
| Example 11 | 14 | 630 | 2 | B | B | B | B |
| Comparative | 15 | 630 | 5 | B | C | C | C |
| Example 4 | | | | | | | |
| Comparative | 16 | 30 | 5 | B | C | C | C |
| Example 5 | | | | | | | |
| Example 12 | 17 | 605 | 1 | B | A | B | B |
| Comparative | 18 | 700 | 2 | B | C | B | B |
| Example 6 | | | | | | | |
| Example 13 | 19 | 630 | 2 | B | B | B | B |
| Example 14 | 20 | 630 | 2 | B | B | B | A |
| Comparative | 21 | 630 | 5 | B | C | C | A |
| Example 7 | | | | | | | |
| Example 15 | 22 | 600 | 1 | B | A | B | B |
| Comparative | 23 | 50 | 1 | C | A | B | C |
| Example 8 | | | | | | | |
| Comparative | 24 | 1200 | 1 | B | A | C | B |
| Example 9 | | | | | | | |
| Comparative | 25 | 1205 | 1 | C | A | C | B |
| Example 10 | | | | | | | |
| Comparative | 26 | 180 | 5 | B | C | C | B |
| Example 11 | | | | | | | |
| Comparative | 27 | 600 | 1 | B | B | C | C |
| Example 12 | | | | | | | |

As clearly shown by the result in Table 2, good results are obtained in any evaluation items of generation of crack, cleaning performance, image defects due to crack, toner filming and durability for intermediate transfer member of “sample of the invention 1 to 15” according to this invention. However intermediate transfer members of “sample of comparisons 1 to 12” have problems in any evaluation items, and show different results of the intermediate transfer member of this invention.

### DESCRIPTION OF SYMBOLS

170 An intermediate transfer member
175 A resin substrate
176 An elastic layer
177 A surface layer
178 An interlayer
178a First layer of interlayer
178b Second layer of interlayer
178c Third layer of interlayer
179 A rigid layer

1. An intermediate transfer member used in an image forming apparatus having a means in which after a toner image carried on a surface of an electrophotographic photoreceptor is first transferred to an intermediate transfer member, the toner image is second transferred from the intermediate transfer member to a transfer material, wherein
the intermediate transfer member is provided with an elastic layer on outer periphery of a resin substrate and a surface layer thereon, wherein
the surface layer is composed of an interlayer and a rigid layer containing at least one selected from metal oxide, oxide containing carbon and amorphous carbon;
the interlayer has a layer thickness of not less than 100 nm and not more than 1,000 nm, hardness of not less than 0.1 GPa and not more than 2.0 GPa, and elasticity modulus of not less than 0.5 GPa and not more than 10.0 GPa; and
the rigid layer has a layer thickness of not less than 0 nm and not more than 50 nm, hardness of not less than 2.0 GPa and not more than 10.0 GPa, and elasticity modulus of not less than 10.0 GPa and not more than 50.0 GPa.

2. The intermediate transfer member of claim 1, wherein the surface layer is formed by superposing layers containing one or more kinds of metal oxides.

3. The intermediate transfer member of claim 1 or 2, wherein the surface layer is a layer composed of silicon oxide as a major component.

4. The intermediate transfer member of any one of claims 1 to 3, wherein the surface layer is formed by means of plasma CVD in which two or more of voltages of different frequency are applied at atmospheric pressure or its neighborhood.

5. The intermediate transfer member of any one of claims 1 to 4, wherein the elastic layer is a layer formed of at least one of chloroprene rubber, nitrile rubber, styrene-butadiene rubber, silicone rubber, urethane rubber and ethylene-propylene copolymer.

6. The intermediate transfer member of any one of claims 1 to 5, wherein the resin substrate is composed of at least one of polyimide, polycarbonate, polyphenylene-sulfide and polyethylene terephthalate.
